(19) United States
(12) Patent Application Publication
(10) Pub. No.: US 2025/0374022 A1
(43) Pub. Date: Dec. 4, 2025

(54) SCALABLE WARNING AND MONITORING SYSTEM FOR COMMUNICATING DURING A MASS SHOOTING

(71) Applicant: Aiki Incoporated, Wilmington, DE (US)

(72) Inventors: Ashley Hamilton, Austin, TX (US); Damian McKeon, Leander, TX (US); Mitchell Butler, Oshawa (CA); Julia Mermelstein, Oshawa (CA); Riley Durant, Pickering (CA)

(73) Assignee: Aiki Incoporated, Wilmington, DE (US)

(21) Appl. No.: 18/875,306

(22) PCT Filed: Jun. 10, 2023
(86) PCT No.: PCT/US2023/068262

§ 371 Date: Dec. 16, 2024

Related U.S. Application Data
(60) Provisional application No. 63/366,618, filed on Jun. 17, 2022.

(51) Int. Cl. H04W 4/90; G06Q 50/26; H04W 4/029

(52) U.S. Cl. CPC H04W 4/90; G06Q 50/265; H04W 4/029

(57) ABSTRACT

Aspects of this disclosure relate to an emergency alert system for reducing risk during a crisis while providing emergency services with information related to the crisis. Other aspects relate to a portable electronic device for assisting a user through a crisis or emergency. The device may be a cell or mobile phone using any form of wired or wireless communication for augmenting information exchange with relevant authorities.

### CROSS-REFERENCE TO RELATED APPLICATIONS

This application claims priority under 35 U.S.C. § 119 to Provisional Patent Application No. 63/366,618, filed Jun. 17, 2022, entitled Early Warning Phone App that Provides Guidance, Notifications, Victim Tracking, and Communication to the Command Post during an Active Attack Crisis, which is hereby incorporated by reference in its entirety.

### BACKGROUND

### Field of the Disclosure

Aspects of this disclosure relate to an emergency alert system for reducing risk during a crisis while providing emergency services with information related to the crisis. Other aspects relate to a portable electronic device for assisting a user through a crisis or emergency. The device may be a cell or mobile phone using any form of wired or wireless communication for augmenting information exchange with relevant authorities.

### Description of Related Art

Emergency number systems, typically a three-digit number dialed into a phone (landline, mobile, internet-based, etc.) were established in order to provide a simple, effective and rapid means to connect people with emergency services. Examples of these numbers include 9-1-1 in North America (and other areas), 1-1-2 in the European Union, 1-1-0 in China, Taiwan and Japan, 1-0-6 in Australia, and 9-9-9 in many other countries. Upon dialing the number, a caller is connected to an operator who gathers information regarding the emergency and dispatches the needed service provider (fire fighting, law enforcement, medical, etc.).

The emergency number system works well for most incidents, enabling needed information to be supplied to first responders in a timely fashion with sufficient accuracy. However, in a mass shooting the emergency number system can fail. Contributing factors include a high volume of calls, confusing and possibly contradictory reports, changing circumstances, and casualties increasing over time. Most significantly, during mass shootings, call volume has overwhelmed the emergency number system. Callers are either unable to reach the dispatch center, or if they are able to reach the center, unable to speak with a dispatcher. Both cellular and land networks become overloaded and non-functional. Critical information is not conveyed to police about whether the shooting is ongoing, how many people may be hiding and where those people may be, how many people are injured and the location of the injured, all of which has resulted in higher casualty rates.

What is needed is a scalable warning monitoring system for communicating during a mass shooting.

### SUMMARY

The systems, methods and devices of this disclosure each have several innovative aspects, no single one of which is solely responsible for the desirable attributes disclosed herein. In one aspect a mobile device includes a display, one or more processors, and a computer-readable medium storing instructions for execution by the one or more processors. The instructions when executed by the one or more processors cause the mobile device to perform the following functions: check lockdown status, present on the display an option for a user of the device to report an emergency, receive a lockdown notification, load a lockdown procedure, update the display with a message regarding the lockdown notification, generate a vault key, transmit the vault key, save the vault key, generate an emergency script, the script relating to the lockdown, and receive an end lockdown notification. The device may further comprise instructions to: transmit an emergency incident report in response to the user having selected the option to report an emergency; and transmit user information. The emergency incident report transmission may further comprise emitting a signal from the mobile device using a wireless network to an emergency service provider. The user information may include at least one of a user identity, a venue, and a user privilege level. The user privilege level may include at least one of a student, a school official and a first responder. The venue may include a school identification. The device may further comprise instructions to: transmit a location of the device. The device may further comprise instructions to: request a room name; and transmit the room name. The device may further comprising instructions to: request an update on whether there is an urgent medical need from anyone in the room; and transmit the urgent medical need update. The device may further comprise instructions to: request an update on the number of people injured in the room; and transmit the injured person update. The emergency script may further comprise directions to: hide, secure a door, and turn off lights. The direction to secure a door may further comprise at least one of locking the door and creating a barrier. The directions may further comprise: encouragement, assurance that help is coming, and a relaxation exercise.

A system may include one or more computer processors and a non-transitory computer storage media storing instructions that when executed by the one or more computer processors cause the system to perform the following functions: receive an emergency incident report, determine a venue associated with the emergency incident report, determine whether a lockdown for the venue should begin, begin the lockdown for the venue, and end the lockdown for the venue. The system may further include instructions to: determine a user privilege level associated with the emergency incident report, and begin the lockdown if the user privilege level is sufficient. The system may further comprise instructions to: increment a counter if the user privilege level is insufficient, and begin the lockdown when the counter is equal to a threshold. The system may further comprise instructions to: begin a timer in response to receiving the emergency incident report, if the user privilege is insufficient, receive an additional emergency incident report, and begin the lockdown if the additional emergency incident report is received within a defined period of time. The system may further comprise instructions to: begin a timer in response to receiving the emergency incident report, receive an additional emergency incident report, and begin the lockdown if the additional emergency incident report is received within a defined period of time and the counter is equal to the threshold. The system may further comprise instructions to: update a status of the venue to lockdown. The system may further comprise instructions to: send an alert to a set of devices identified with the venue, the alert sent with a push notification, the venue including a number of devices, the set of devices including all or fewer than all of the number of devices in the venue, wherein the status update is available to all the devices in the venue. The system may further comprise instructions to: trigger third-party lockdown hooks. The third-party lockdown hooks may further comprise at least one of: call a country-specific emergency services phone number, contact a law enforcement office, contact a hospital, activate an electronic door lock at the venue, or activate an audible alarm at the venue. The system may further comprise instructions to: determine a user identity associated with the emergency incident report. The system may further comprise instructions to: access a venue map, receive a user location, and update the venue map with the user location. The system may further comprise instructions to: receive a room name; and receive an injury report associated with the room name. The system may further comprise instructions to: update a status of the room, the status relating to at least one of occupancy of the room and injury reports. The system may further comprise instructions to: receive a message for transmitting to the identified user, retrieve a vault key associated with the identified user; encrypt the message, and store the encrypted message as an unread message in a vault associated with the identified user. The system may further comprise instructions to: increment a message count of the user's unread messages, log a record that the encrypted message was stored in the vault associated with the identified user, and send a notification to the identified user regarding the unread message. The system may further comprise instructions to: update the status of the venue to lockdown ended, generate report metrics for the venue, and erase a lockdown log of personal information.

One aspect may be a method for gathering information and assistance during a crisis at a venue. The method may include receiving a plurality of emergency incident reports, each emergency incident report associated with a person, all of the reports associated with the same emergency at the venue, the venue having at least one room, receiving occupancy information about the room, and updating a map of the venue with the occupancy information. The method may further include: receiving health information about a room occupant, and updating a map of the venue with the health information. The health information may include a count of injured people in the room. The method may further comprise: opening a two-way dialogue with one of the people associated with one of the plurality of emergency incident reports. The occupancy information may include a count of a number of people in the room. The method may further comprise: transmitting a message for one of the people associated with one of the plurality of emergency incident reports, and receiving a message from one of the people associated with one of the plurality of emergency incident reports.

In accordance with an aspect of the invention, there is provided a computer program product configured to be operable to check a lockdown status, present on a display an option for a user of a mobile device to report an emergency, receive a lockdown notification, load a lockdown procedure, update the display with a message regarding the lockdown notification, generate a vault key, transmit the vault key, save the vault key, generate an emergency script, the script relating to the lockdown, and receive an end lockdown notification.

In accordance with an aspect of the invention, there is provided a computer program product configured to be operable to receive an emergency incident report, determine a venue associated with the emergency incident report, determine whether a lockdown for the venue should begin, begin the lockdown for the venue, and end the lockdown for the venue.

In accordance with an aspect of the invention, there is provided a computer program product configured to be operable to receiving a plurality of emergency incident reports, each emergency incident report associated with a person, all of the reports associated with the same emergency at a venue, the venue having at least one room, receiving occupancy information about the room, and updating a map of the venue with the occupancy information.

The foregoing has outlined rather broadly the gestures and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of this disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating one example of an environment for operating a mobile device.

FIG. 2 is a flowchart illustrating one process for requesting permission for user notification.

FIG. 3 is a block diagram illustrating one process for a user to receive a lockdown notification.

FIG. 4 is a block diagram illustrating one process for generating an emergency script.

FIG. 5 is a block diagram illustrating one process for reporting an emergency.

FIG. 6 is a flowchart illustrating one process for requesting permission for reporting user location.

FIG. 7 is a block diagram illustrating one example of a configuration of devices in a cloud computing system.

FIG. 8 is a flowchart illustrating one process for receiving an emergency incident report and beginning a lockdown.

FIG. 9 is a flowchart illustrating one process for determining whether a lockdown for a venue should begin.

FIG. 10 is a block diagram illustrating one process for beginning a lockdown for a venue.

FIG. 11 is a block diagram illustrating one process for automatically engaging security protocols for a lockdown.

FIG. 12 is a block diagram illustrating one process for tracking users and injuries on a map.

FIG. 13 is a block diagram illustrating one process for sending a message to a user.

FIG. 14 is a block diagram illustrating one process for ending the lockdown.

### DETAILED DESCRIPTION

Various aspects of the disclosure are described more fully herein with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based at least in part on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure may be embodied by one or more elements of a claim.

In one aspect a warning and monitoring system for communicating during a crisis, for example a mass shooting, may include a reporting application and a response dashboard, both operable on and accessible through electronic devices. The reporting application may be software (App) installed on an electronic device, for example a mobile phone, laptop, or other computer. In one aspect, a group of people all having a connection to a particular venue may have the app installed on their mobile phones, for example. Examples of a venue include a school, place of worship, workplace, stadium, shopping mall, movie theater and so on. In the example of a school, for illustrative purpose “Springfield High,” the students and staff at the school could download the App and be identified as belonging to the venue Springfield High. In one aspect there may be a particular App front that is downloaded, only associated with Springfield High. In one aspect there may be a generic App in which that venue is selected from among multiple venues. In one aspect a user identity may be associated with a venue or multiple venues. Other people who also have access to Springfield High, for example parents, temporary school workers, delivery personnel—the common connection being the school in this example—may also have the App and be associated with the venue. At installation, the App may request various permissions, for example location and push notification. The App may run on the phone in the background, always on, or the App may be opened and accessed when needed.

One aspect of the system is the response dashboard, which may be software installed on an electronic device, for example a mobile phone, laptop, desktop computer, other computer, or it may be located in the cloud with a local representation available on an electronic device. The response dashboard may include a map of each venue. Associated with a venue, for example Springfield High school, are the members of the venue, in the above example students, staff and other people connected with Springfield High, who have downloaded the App (downloading the App is unnecessary to be associated with the venue, for example law enforcement may be associated with one or more venues in their jurisdiction, or ambulance services may be associated with one or more venues). Members have privilege levels, for example normal, administrator, responder, etc. For example a student may have a normal privilege level while a teacher may have an administrator privilege level. When a user opens the App and presses an emergency button, the response dashboard logs an emergency incident report. Once an established criteria is met regarding incident reports, the response dashboard activates a lockdown for the venue. Examples of criteria that may be established include a report by one user with administrator privilege level, a certain number of reports within a certain timeframe by users with a normal privilege level (for example, five reports by students within 10 minutes), and a single report by a user with responder privilege level.

Although three privilege levels are described, one of skill in the art will recognize that more or fewer privilege levels may be implemented. One of skill in the art will also recognize that privilege levels may have different scope than what is described herein, and different amounts of overlap.

A lockdown is an alert and change in status for a location, reflecting the possibility of a mass emergency, for example a spree shooter, or mass shooter, or the shooting of a single person, or the observation of an unauthorized person with a gun, or another type of emergency. In one aspect, the lockdown serves to notify those with the App that the venue may be unsafe, and may provide some guidance to the users on how to be safer and get through the emergency. In one aspect, the lockdown provides authorities with information on where people are, how many injured people there may be, and a streamlined and focused way to communicate with those people. Additionally, by using the App, phone resources such as the emergency number system remain open and reachable so that other emergencies can be addressed during the emergency at the venue that resulted in the lockdown. The lockdown may be used to trigger security protocols either automatically or in response to the lockdown, for example teachers locking the door to a classroom and turning lights off.

Upon activating a lockdown, status for the venue (Springfield High) changes to lockdown. Everyone registered with Springfield High who opens the App will see that status reflected by the App. Those users who gave permission for notifications will also receive an alert on their phone notifying them that Springfield High is on lockdown status. In one aspect, a student who received a lockdown notification (or opened the App) could be asked a series of questions through the App, for example their room location, whether they or others are injured, how many people are in their room, whether the door is locked, whether the lights are off, is there a barricade, are they being silent, information about their mental health status, and so on. The App could also offer encouragement, advice and guidance for first aid and best-practices to increase survival during the emergency, and so on. The information supplied by the student (or other user) could be sent in real time, or a report could be compiled and sent at the end, or at different intervals (depending on the answers to the questions, or progress through the questions, or based on other triggering events). In one aspect the question set may be stored within the App and may not represent dialogue with a thinking agent (for example a person). In one aspect a chat dialogue may be opened with a student (or other user) and a first responder (for example) with active, two-way, free-form communication between the responder and the student. In one aspect there may be an electronic mailbox with encryption, through which a student and officials can message each other.

The response dashboard may be accessed by those with a sufficient privilege level, for example the highest privilege level-responder (a label, not necessarily a function). The dashboard may include a map of the venue, in this example a map of Springfield High, showing the entire campus, which is pre-loaded into a database for the venue. The map may include room labels, as might be used by students and teachers, for example. Room labeling may be a number, for example room 12, 206-b, or a name, for example Auditorium, Gym, Chemistry lab. The map may be top-down (plan) view, cross-sectional, 3D, and it may be manipulated by a user for different perspectives, views, with zoom in/out functionality. As emergency incident reports are received, the map may update with the number of people in rooms, illustrating whether they are injured and where they are, whether doors are locked and other status or condition information regarding people, the venue and the event. Rooms or people may be color-coded, for example red for injured, or yellow for a room that has not completed a report, or gray if there has been no report from a room, yellow for a room that is not locked and not barricaded, or green for users who are uninjured (and may be shown on the reporting dashboard as having reported and out of danger, for example off-campus). The map may include statistical information, for example the percentage of students who have responded via the App, or the percentage who are in locked rooms, or injured/uninjured, and so on. The map may include raw numbers and data as well. In one aspect, the map may include the location and progress of responders (for example police officers, school officials, medics, school resource officers, etc.) as they progress through the venue.

In one aspect, when a lockdown begins, that may trigger other events or notifications, for example an alarm system sounding, or door locks activating, or alerts to law enforcement, or to hospitals, and so on. Event triggering may be automatic, manual or a combination. A user with the responder (highest) privilege level may be able to reverse the events, for example turn off an alarm, unlock one or more doors, and so on, as needed while the emergency is resolved.

Once the venue is clear of danger and the emergency is over, a user with an appropriate privilege level may issue an end-lockdown command through the response dashboard. This may reset the system to its pre-lockdown state, and it may issue a notification to the venue members (either actively with a push notification or passively by updating the venue status reflected in the App). An end-lockdown status update may automatically trigger electronic door locks to unlock, or deactivate an alarm, or reverse other actions that were triggered by the lockdown. A report may be compiled with different information and personally identifying data may be removed from the system, reports, or otherwise from any storage.

Frequent mention through the disclosure is made to an emergency of a mass shooting, but one of skill in the art will recognize that other emergencies may be addressed by the App and reporting dashboard, for example fire, flood, earthquake, building collapse, entrapment, or even smaller scale emergencies, such as a teacher collapsing during school hours. Furthermore, while frequent mention and reference is made to a school, with students, teachers and other school officials, one of skill in the art will recognize that other venues are included as previously mentioned (place of worship, workplace, mall, sport stadium/arena, event center, music hall, hotel, restaurant, and so on) with corresponding member sets.

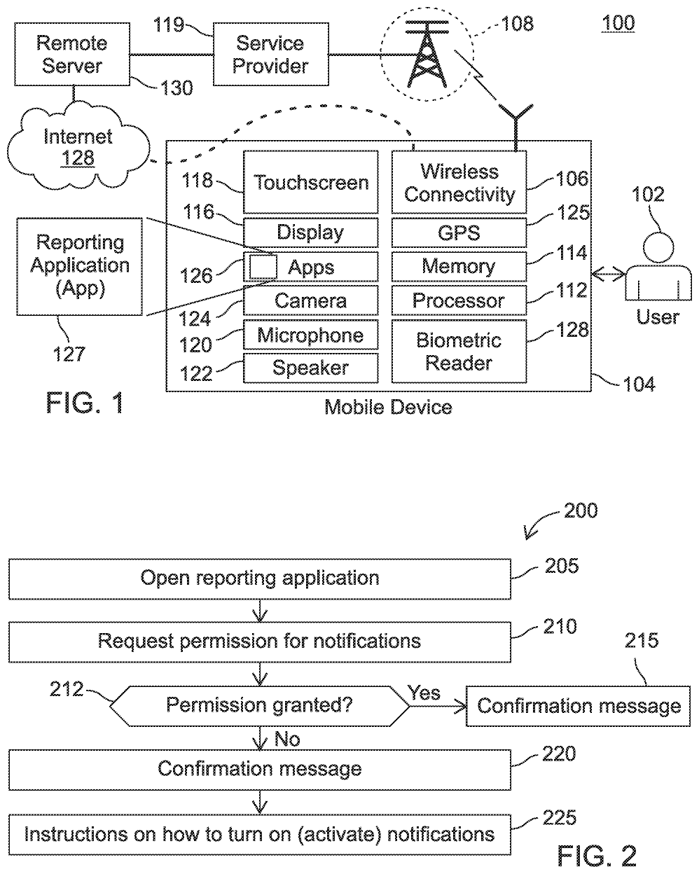

The block diagram of FIG. 1 depicts exemplary environment 100 in which various aspects of the disclosure may be implemented. User 102 may be in physical possession of mobile device 104 that has various data processing and communications features. Mobile device 104 may be a smartphone-type apparatus that has wireless network connectivity module 106 for placing telephone calls or receiving/transmitting messages over mobile telecommunications network 108 managed by service provider 110, such as VERIZON, AT&T, NEXTEL, SPRINT, T-MOBILE, US CELLULAR, BOOST, CRICKET, VODAFONE, TELEFONICA, ORANGE, TIM, TELECOM ITALIA, and others. Wireless network connectivity module 106 may also be utilized for data communications other than voice telephone calls. Aside from utilizing mobile telecommunications network 108, wireless network connectivity module 106 may also be configured for GSM, CDMA, WCDMA, 4G, LTE, EDGE, the Internet, Wi-Max, Wi-Fi (IEEE 802.11x), Bluetooth, and other similar wireless communications functions. Mobile device 104 can also be connected to the Internet at least via service provider 110.

Mobile device 104 may have stored thereon programmed instructions that comprise software applications that provide functionality in addition to making and receiving telephone calls, such as simple message service (SMS) text messaging, e-mail, calendars/to-do, photography, videography, media playback, and web browsing, among many others. The various functions of mobile device 104 can be handled by general purpose data processor 112. In particular, general purpose data processor 112 executes programmed instructions that are stored in memory 114. Wireless network connectivity module 106 cooperates with processor 112 to perform at least one wireless communications function, for example, for voice and/or data. Alternatively, in some aspects, mobile device 104 may not include wireless network connectivity module 106. In one aspect, the tangibly embodied instructions, when executed may perform authentication of user 102 for accessing mobile device 104.

The results of the computations performed by general purpose data processor 112, and in particular a user interface (not illustrated) for various applications, can be displayed or output to screen 116. Commonly, screen 116 may be a liquid crystal display (LCD) or similar display device of varying dimensions fitted to the housing of mobile device 104. Inputs for the computation and other instructions to mobile device 104 can be provided via touch input panel 118 that may be overlaid on screen 116. In certain implementations, screen 116 and touch input panel 118 are integrated. Besides touch input panel 118, there may be alternative input modalities such as a keypad (not shown). The arrangement of the keys on the keypad may be different to fit within the dimensions of mobile device 104. Along these lines, other input/output devices such as microphone 120 for receiving audio or voice signals may be included, as well as speaker 122 for outputting audio. For capturing and providing visual data to mobile device 104, there may be integrated camera 124 comprising a lens, an imaging sensor, and a dedicated image processor connected to general purpose data processor 112. Camera 124 may be utilized to capture still images as well as a video stream, the data for which is stored on memory 114. Global Positioning System (GPS) 125 may include a receiver and associated circuitry for receiving and processing satellite signals for positioning and location information. GPS 125 may include other location and positioning technology, for example, for use indoors where there is no direct GPS signal, or to augment other signals received to approximate a location or improve positioning.

There are numerous variations of mobile device 104 or smart phone that are currently available on the market, including the GALAXY from SAMSUNG or the IPHONE from APPLE. It is also contemplated that various aspects of the disclosure may be implemented on mobile devices (and that mobile device 104 may be a device other than a cellular or phone device) other than smartphones or cellular phones, such as tablet-type mobile devices, full feature media player devices, computing devices including laptops and other portable electronic devices. The specifics of mobile device 104 are presented by way of example only and not of limitation, and any other suitable mobile device 104 may be substituted.

In one aspect, mobile device 104 is used to authenticate user 102 for access to applications or functions 126 associated with mobile device 104. In this example, mobile device 104 is protected from unauthorized access (e.g., the mobile device may be in a locked mode), and the disclosed method for authenticating user 102 may be utilized to permit access. User 102 may download, transfer, store or otherwise save software on mobile device 104, in one aspect reporting application (App) 127. App 127 may be stored or reside with Applications 126 and be loaded, executed or used by processor 112, either full time or as needed. The following description will be in the context of mobile device 104, but one of ordinary skill in the art will readily recognize the applicability or non-applicability and necessary substitutions for various disclosed features to implement the contemplated mobile device-based authentication in other contexts, such as on a laptop-style portable personal computer.

With additional reference to FIGS. 2-6, use of App 127 is illustrated. FIG. 2 is a flowchart illustrating process 200 for granting permission to App 127 for user notification, for example a push notification during a lockdown. In one aspect, when user 102 opens reporting application 205 for the first time, process 200 begins. Interaction with App 127 may be through display 116, with buttons allowing user 102 to select ‘Yes’ or ‘No’ answers. In block 210, App 127 may request permission from user 102 for notifications. Granting permission for notifications means that when a lockdown is initiated, mobile device 104 may signal an alert to user 102. Examples of alerts include, either separately or in combination: sound, visual cues and vibration.

User 102 may grant or deny permission, block 212. If notification permission is granted then a confirmation message, block 215, may be shown on display 116. If notification permission is denied then a confirmation message, block 220, may be shown on display 116. In case user 102 later decides to grant permission for notifications, App 127 may provide instructions on how to turn on notifications at another time, block 225. Permissions for user notification may be given after a first use of App 127.

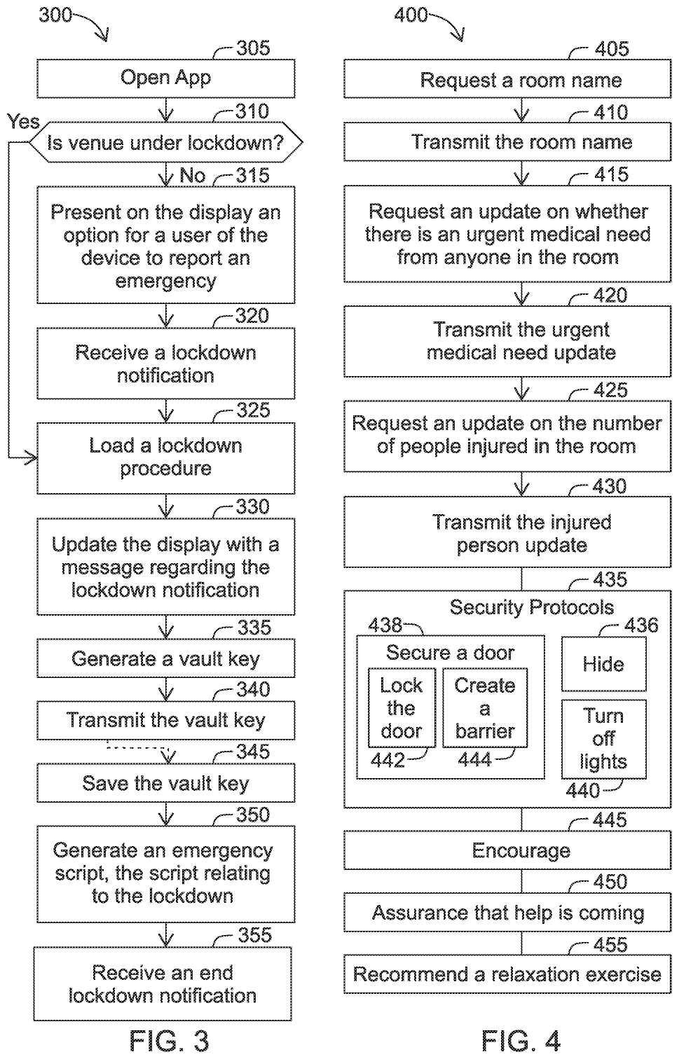

FIG. 3 is a block diagram illustrating process 300 for user 102 to receive a lockdown notification through App 127. In one aspect, App 127 is already open and running on mobile device 104. App 127 may be in the background, or in a sleep mode, or active among a group of other apps on mobile device 104. At some point, App 127 is opened on mobile device 104, block 305. After opening, App 127 may be closed, or it may remain open. After opening, App 127 determines if the venue is under lockdown, block 310. In one aspect, App 127 may determine this by checking whether any notifications have been received by mobile device 104. In one aspect, App 127 may determine this by checking with a system running the response dashboard. If the venue is not under lockdown then App 127 may present the option of reporting an emergency by showing on display 116 a button that, if selected by user 102, reports an emergency, block 315. An emergency reported by user 102 may be received by the system running the response dashboard as an emergency incident report, which may or may not result in a lockdown.

While App 127 is open, at some point a lockdown notification may be received, block 320. In one aspect, once a lockdown is recognized, App 127 may load a lockdown procedure, block 325. A lockdown procedure may include various processes and blocks as described below, for example generating a vault key for encrypted communication, or sending user identification and location information to the response dashboard, or stepping the user through a script to help with the emergency. Once a lockdown is recognized, display 116 may update with a message regarding the lockdown, block 330. As previously mentioned, other forms of alert may be used, for example sound and vibration, in addition to or instead of the message on display 116.

Once user 102 opens App 127 during a lockdown, or a lockdown is triggered while App 127 is open, permission to forward the user's location may be requested, process 600 in FIG. 6.

FIG. 6 is a flowchart illustrating process 600 for requesting permission for reporting user location. During a lockdown, App 127 will request permission from user 102 to forward the user's location to responders, block 610. This may appear as a question on display 116, for example ‘Can we send your location to responders?’ with a button on display 116 for ‘Yes’ and a button for ‘No.’ User 102 may decide whether to grant location reporting permission, block 615. If user 102 decides to grant permission then a confirmation message may appear, block 620. The location information may be derived in part or wholly from GPS 125, or from other signal capability in mobile device 104. In one aspect, mobile device 104 may allow geo-location to be established with expo-location services through React Native. The location information may be sent immediately after block 615 or some time period after block 615.

If user 102 decides not to share their location then a confirmation message may appear, block 220. In one aspect and optionally, instructions may be provided on how to turn on (activate) location permission, block 630, if user 102 changes their mind or makes an error. In one aspect and optionally, during the lockdown, either App 127 or the responders through the reporting dashboard may again request user's location information, block 635. Block 610 differs from block 635 in that block 610 may execute on every mobile device where App 127 is open and the user is associated with (or possibly at) the venue where the lockdown is occurring. Block 635 may not execute on every mobile device 104, and not necessarily on every mobile device 104 for which user 102 has denied location permission. Block 635 may execute during an emergency script (see FIG. 4), it may be triggered by first responders or other authorities through the reporting dashboard, it may be triggered during a live chat with authorities, or through other mechanisms. If user 102 grants permission from a request in block 635 then location information may be derived in part or wholly from GPS 125, or from other signal capability in mobile device 104. The location information may be sent immediately after block 635 or some time period after block 635.

Returning to FIG. 3, in one aspect, as a result of the lockdown procedure, mobile device 104 may generate a vault key, block 335. Mobile device 104 may transmit the vault key, block 340, and save the vault key, block 345. A vault key is a key allowing encrypted communication between systems having a copy of the vault key. In one aspect, the vault key may be used to store and retrieve encrypted messages between a user and authorities while they communicate during the lockdown.

In block 350, App 127 may generate an emergency script relating to the lockdown. FIG. 4 provides more detail on the emergency script. Block 350 may be optional such that an emergency script may not be generated, or if a script begins, it may not continue or finish.

When the emergency has ended and authorities have cleared the venue, user 102 may receive an end lockdown notification, block 455.

FIG. 4 is a block diagram illustrating process 400 for generating an emergency script. Process 400 may be a single question, answerable with ‘Yes’ or ‘No’, or it may be a more complex question, or it may be multiple questions answerable in different ways. Although presented in FIG. 4 as part flow diagram and part block diagram, a different order may be used than that illustrated in FIG. 4 and different questions may be presented. Process 400 is exemplary only and one of skill in the art will recognize that best practices regarding information gathering, security protocols, and mental buttressing will guide the form, nature, and pacing of the script. Portions of the script, entire sections, or all of it may be repeated. Re-ordering of the blocks and a change in the flow are also expected, as well as additional commentary not illustrated in FIG. 4.

In one aspect, the emergency script may request a room name from user 102, block 405. While ‘room’ is referenced throughout the description, one of skill in the art will understand this is not limited to a room and includes a location or namable place identifiable and associated with the venue. The room name (or location) will be tied to the venue and may be a room number (2, 107, 4B, etc.) a room name (Einstein lab, or History room, etc.), or a room location (Theater 2, Theater 3, kitchen), or a store name, and so on. The request may be multi-faceted, inquiring whether user 102 is at the venue at all, with a ‘No’ response ending the script with a warning to avoid the venue. The script may diverge prior to obtaining the room name, to establish medical needs, and then return to a specific room name. For example, the script may ask user 102 if they are at the venue, with an affirmative response populating a next question regarding injuries, to return to a room name at a later time. In block 410, mobile device 104 transmits the room name using App 127. As previously discussed, transmission of information may occur at times other than that illustrated in FIG. 4 and need not be immediately after receiving a room name. Other intervening blocks in the script may be executed prior to sending the update. Block 405, requesting a room name, differs from blocks 610 and 635, regarding location information. Location information may be derived from a signal or signals received by mobile device 102 and analyzed for position and location information, which may be through GPS or other methods. Block 405 represents a request to user 102 for a specific room name (or location name) in which user 102 is located, barricaded, stuck, injured, hiding, and so on. Location information electronically derived may not be accurate, complete, or available, depending on the circumstances. User 102 may grant permission to forward location information (blocks 610 and 635) and they do not need to know where they are located, or the name or number of the room.

In block 415, App 127 may request an update on whether there is an urgent medical need from anyone in the room. In one aspect, this may be a single question. In one aspect, this may include multiple questions. This question or these questions may be answerable with ‘Yes’ or ‘No’, involve locations of injured people, nature of injuries, and urgency. In block 420, mobile device 104 transmits the urgent medical need update using App 127. As previously discussed, transmission of information may occur at times other than that illustrated in FIG. 4 and need not be immediately after receiving the medical update. Other intervening blocks in the script may be executed prior to sending the update.

In block 425, App 127 may request an update on a number of people injured in the room. In block 430, mobile device 104 transmits the number of injured people using App 127. As previously discussed, transmission of information may occur at times other than that illustrated in FIG. 4 and need not be immediately after receiving the medical update. Other intervening blocks in the script may be executed prior to sending the update.

Block 435 provides security protocols associated with the emergency and may include best practices for surviving the emergency. The script may include recommendations that user 102 hide, block 436, secure a door, block 438, or turn off lights, block 440. In one aspect, the recommendations may be formed as questions, for example ‘Are you out of sight?’ ‘Is the door locked?’ or ‘Are the lights off?’ to which user 102 could press a button on touch screen 118 for either ‘Yes’ ‘No’ or ‘I don't know.’ Depending on how user 102 responds, additional prompts and script may follow, with recommendations to help user 102. The recommendations may be generic or the recommendations may be tailored to the environment, venue, and even the room in which user 102 is located. The script may recommend more than one of the protocols, or all of them. Hiding may involve being quiet, getting in closets, cabinets, or other locations that are out of sight. Securing a door may include a recommendation to lock the door, block 442, create a barrier, block 444, or both. The script may provide details on how the door locks are operated. The script may provide guidance on how to create barriers against a door.

Blocks 445, 450 and 455 involve mental buttressing and may occur as illustrated in FIG. 4, at different points in the script than illustrated in FIG. 4, at multiple times, in the beginning, middle or end of the script. Examples of encouragement, block 445, include ‘You're doing great [name]’, That's OK [name]! You're doing great. We'll connect you with other students in the room to find out', ‘No problem, you're doing great!’, ‘Great job [name].’ Block 445 may be executed whenever appropriate to encourage user 102. For example, to a question about whether the door is locked, if user 102 answers ‘No,’ the script may jump to block 445 before returning block 438 reminding user 102 to create a barrier, block 438.

In block 450, App 127 includes assurance that help is coming, for example that police are enroute, or medics, or both.

In block 455, App 127 may recommend a relaxation exercise, for example taking deep, slow breaths. Block 455 may be executed as a standard part of the script, or in response to input by user 102.

The emergency script may be pre-loaded in App 127. In one aspect, the emergency script may be interactive, between user 102 and authorities. In one aspect, there may be options to open a chat dialogue outside the standard flow of the script, the chat dialogue being whatever questions or information user 102 wishes to convey. The information obtained from the script may be transmitted in real time, sent at certain intervals based on factors such as network bandwidth, checkpoints within the script other than those illustrated in FIG. 4, time intervals, or demand-driven from the response dashboard, for example.

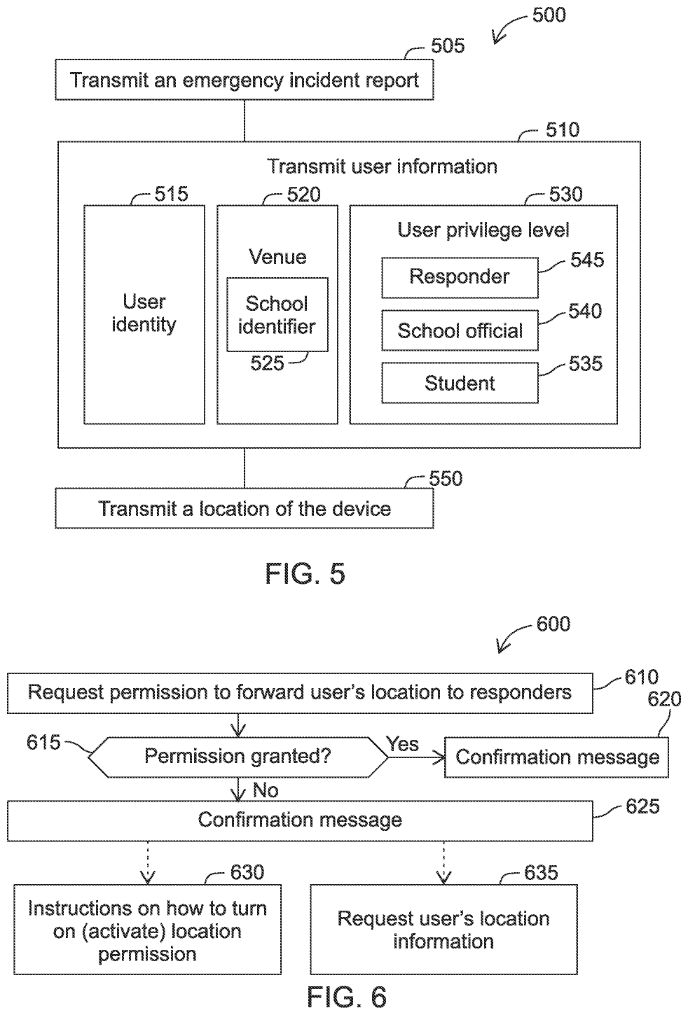

Returning to block 315 of FIG. 3, user 102 may open App 127 when the venue is not under lockdown, for example to report an emergency such as a gunfire, or something user 102 believes to be gunfire. App 127 may be used to report any incident or emergency, for example a fire, illness, building collapse, etc. When user 102 opens App 127, a button may appear on display 116, reading ‘Help,’ or ‘Press to report an emergency’ or ‘Need assistance’ for example. When user 102 presses this button on touch screen 118 (or otherwise activates the emergency notification through some other means), App 127 begins process 500 for reporting the emergency, as illustrated in FIG. 5. There may be an intervening button reading ‘Are you sure?’ or ‘Slide to confirm,’ for example, to reduce the likelihood of an accidental emergency triggering.

FIG. 5 is a block diagram illustrating process 500 for reporting an emergency. After user 102 presses touch screen 118 to report an emergency, App 127 transmits an emergency incident report, block 505. In one aspect, the emergency incident report may contain a venue identity. In one aspect, a venue identity is transmitted later or not at all. iApp 127 may transmit the emergency incident report to the response dashboard.

Block 510 relates to transmitting user information. In one aspect, user identity 515 may be transmitted with or after the emergency incident report, or with block 510. In one aspect, venue 520 is transmitted to the response dashboard. In one aspect, user identifying information is uniquely associated with a venue. As previously mentioned, venue 520 may be, for example, a school (elementary, middle, high, junior high, community college, university, graduate school, professional school, trade school), a place of worship, a mall, theater, sports arena, workplace, company, etc. In the example of a school, school identifier 525 may be used.

Either included with the user information or separately determined, is user privilege level 530. In one aspect, three tiers of privilege may be available. The third tier may be the lowest privilege level, where user 102 can send an emergency alert but which will not, in isolation, cause a lockdown to be triggered. Multiple reports from users with third tier privilege may be required before a lockdown is triggered. The second tier may be a middle level privilege level, where an emergency incident report from a single user with the second tier of privilege may cause a lockdown to be triggered. The first tier of privilege may have the same triggering authority as the second tier, but additionally have access to the reporting dashboard and associated functionality (for example, the authority to cancel a lockdown).

In one aspect and following the example of a school being the venue, the third tier may include the students at the school having student privilege, block 535. School administrative staff, teachers and other school employees may have school official privilege, block 540, or the second tier privilege. First responders (police, fire, ambulance services), a school resource officer, school principal, a risk management officer, an independent school district (ISD) officer, may have responder privilege, block 545, or the first and highest privilege level. In one aspect, a single emergency report from a third tier privilege level user, for example a student, may not trigger a lockdown, however school personnel (for example principal, school resource officer, etc.) may be notified.

In block 550, device location is conveyed. As previously discussed with respect to FIG. 6, permission for sending the device location may be obtained from user 102.

FIG. 5 illustrates blocks as discrete transmission activities, however one of skill in art will recognize that the order of the blocks in FIG. 5 may differ, or the transmissions may occur (or information made available) simultaneously, or that information regarding user 102 (for example, user identity, venue, privilege level) may be available by the reporting dashboard from sources other than user 102 or mobile device 104.

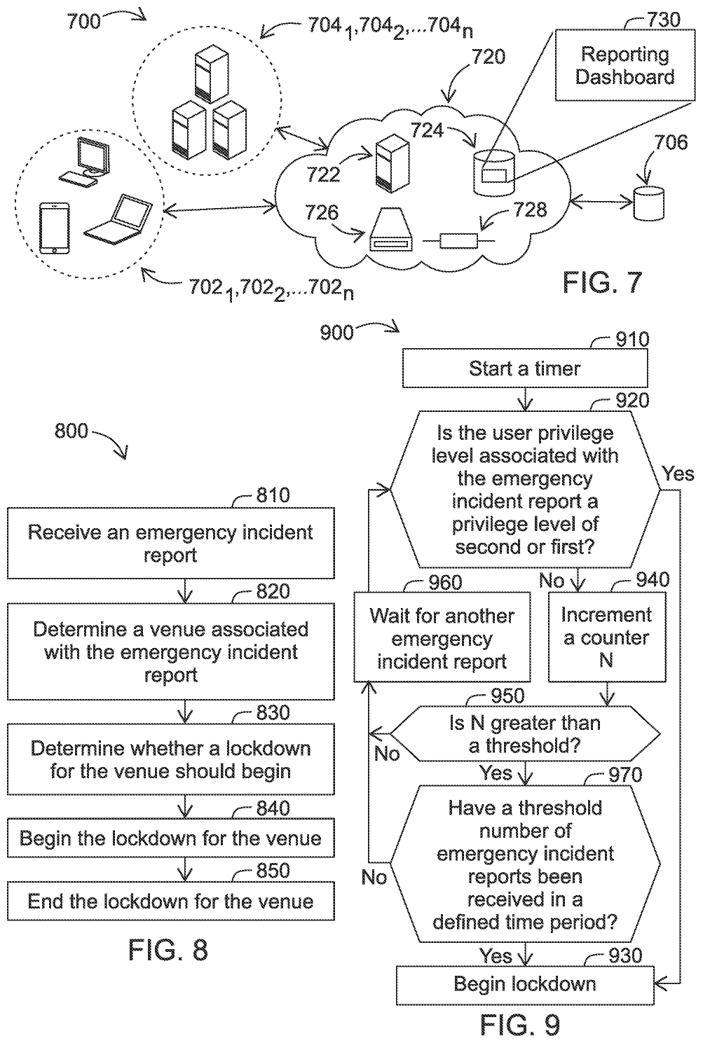

FIG. 7 illustrates an exemplary configuration of devices in cloud computing system 700. One aspect of the reporting dashboard may be implemented in cloud computing system 700. Cloud computing is a type of Internet-based computing in which a variety of resources are hosted and/or controlled by an entity and made available by the entity to authorized users via the Internet. A variety of electronic devices can communicate via a network for purposes of exchanging content and other data as well as making use of cloud-based services. The system can be configured for use on a wide variety of network configurations that facilitate the intercommunication of electronic devices, as well as offering scalability in order to handle large amounts of traffic and demand from the electronic devices. For example, each of the components of system 700 in FIG. 7 can be implemented in a localized or distributed fashion in a network.

System 700 can be configured to include cloud computing resources 720. The cloud resources can include a variety of hardware and/or software resources, such as cloud servers 722, cloud databases 724, cloud-based storage 726, cloud networks 728, cloud applications, cloud platforms, and/or any other cloud-based resources. In some cases, the cloud resources are distributed. For example, cloud-based storage 726 can include multiple storage devices. In some cases, cloud resources can be distributed across multiple cloud computing systems and/or individual network-enabled computing devices. For example, cloud computing resources 720 can communicate with servers 7041, 7042, . . . , 704N (collectively referred to as “704”), database 706, and/or any other network-enabled computing device to provide the cloud resources.

Furthermore, in some cases, the cloud resources can be redundant. For example, if cloud computing resources 720 is configured to provide data backup services, multiple copies of the data can be stored such that the data is still available to the user even if a storage resource is offline, busy, or otherwise unavailable to process a request. In another example, if cloud computing resource 720 is configured to provide an application, for example software-as-a-service (SAAS), the SAAS can be available from different cloud servers so that users may be served from any of the different cloud servers. Algorithms can be applied such that the closest server or the server with the lowest current load is selected to process a given request.

In system 700, a user interacts with cloud computing resources 720 through user terminals 7021, 7021, . . . , 702N (collectively “702”) connected to a network by direct and/or indirect communication. User terminals 702 may include electronic devices as previously described, for example mobile device 104. Cloud computing resources 720 can support connections from a variety of different electronic devices, such as servers; desktop computers; mobile computers; handheld communications devices, e.g., mobile phones, smart phones, tablets; set top boxes; network-enabled hard drives; and/or any other network-enabled computing devices. Furthermore, cloud computing resources 720 can concurrently accept connections from and interact with multiple electronic devices. Interaction with multiple electronic devices can be prioritized or occur simultaneously.

Cloud computing resources 720 can provide cloud resources through a variety of deployment models, such as public, private, community, hybrid, and/or any other cloud deployment model. In some cases, cloud computing resources 720 can support multiple deployment models. For example, cloud computing resources 720 can provide one set of resources through a public deployment model and another set of resources through a private deployment model.

In one aspect, user terminal 702 can access cloud computing resources 720 from any location where an Internet connection is available. However, in other cases, cloud computing resources 720 can be configured to restrict access to certain resources such that a resource can only be accessed from certain locations. For example, if cloud computing resources 720 is configured to provide a resource using a private deployment model, then cloud computing resources 720 can restrict access to the resource, such as by requiring that user terminal 702 access the resource from behind a firewall.

Cloud computing resources 720 can provide cloud resources to user terminals 702 through a variety of service models, such as Software as a Service (Saas), Platforms as a service (PaaS), Infrastructure as a Service (laaS), and/or any other cloud service models. In some cases, cloud computing resources 720 can provide multiple service models to user terminal 702. For example, cloud computing resources 720 can provide both SaaS and laaS to user terminal 702. In one aspect, cloud computing resources 720 can provide different services to different user terminals 702. For example, cloud computing resources 720 may provide SAAS, in conjunction with App 127 to user terminal 7021 and reporting dashboard 730 to user terminal 7022.

In some cases, cloud computing resources 720 can maintain an account database. The account database can store user identification. The user identification may include privilege level, such as software the user is permitted to use and a venue connection or connections. Additional stored information may include geographic maps of venues, third-party contact information, etc. There may also be usage information, such as computing resources consumed, data storage location, incident logs and reporting information, personal configuration settings, etc. In some cases, the account database can reside on a database or server remote to cloud computing resources 720 such as servers 704 or database 706.

Cloud computing resources 720 can provide a variety of functionality that requires user interaction. Accordingly, a user interface (UI) can be provided for communicating with cloud computing resources 720 and/or performing tasks associated with the cloud resources. The UI can be accessed via an end user terminal 702 in communication with cloud computing resources 720. The UI can be configured to operate in a variety of client modes, including a fat client mode, a thin client mode, or a hybrid client mode, depending on the storage and processing capabilities of cloud computing resources 720 and/or the user terminal 702. Therefore, a UI can be implemented as a standalone application operating at the user terminal in some embodiments. In other embodiments, a web browser-based portal can be used to provide the UI. Any other configuration to access cloud computing resources 720 can also be used in the various embodiments

With additional reference to FIGS. 8-14, use of reporting dashboard 730 is illustrated. FIG. 8 is a flowchart illustrating process 800 for receiving an emergency incident report and beginning a lockdown. In the scenario of a school shooting, for example user 102 opening App 127 and declaring an emergency, which results in an emergency incident report being sent. Mobile device 104 of FIG. 1 may be one of user terminal 702 of FIG. 7, and as such transmit the emergency incident report to reporting dashboard 730.

In block 810, reporting dashboard 730 receives the emergency incident report. Either included with the report or otherwise determined, reporting dashboard 730 determines a venue associated with the emergency incident report, block 820. Venue may be determined in different ways, for example cross-referencing a database, or venue may be unique to a group running each version of reporting dashboard 730, or it may be associated with a user identification, etc. Once a venue is determined, reporting dashboard 730 determines whether a lockdown for the venue should begin, block 830.

Criteria for determining whether to begin a lockdown may vary, from beginning a lockdown based on a single emergency report from user 102 (where all users have second or first tier privilege level), to requiring a certain number of reports within a certain period of time, to requiring at least one second or first tier privilege level, etc. Once the criteria is met for a lockdown, reporting dashboard 730 begins the lockdown for the venue, block 840. All Apps 127 with users 102 who are associated with the venue under lockdown may be updated to reflect the lockdown when Apps 127 are open or run on user terminals 720 (for example mobile devices 104). Once the situation is resolved and the venue is safe, reporting dashboard 730 may be used to end the lockdown for the venue, block 850. Once the lockdown is ended, All Apps 127 with users 102 who are associated with the venue that was under lockdown may be updated to reflect that the lockdown is over.

FIG. 9 is a flowchart illustrating process 900 for determining whether a lockdown for a venue should begin. After receiving an emergency incident report, reporting dashboard 730 may start a timer, block 910. The timer may be used to determine if enough emergency incident reports are received within a defined time period. Reporting dashboard may determine If the user associated with the emergency incident report has a high enough privilege level, for example second or first, block 920. If the privilege level is high enough, then begin the lockdown, block 930.

If the privilege level is not high enough, for example third tier, then increment a counter to track the number of emergency incident reports, block 940. In block 950, reporting dashboard 730 may determine if the count is greater than a threshold, for example 2, 3, 4, 5, 6, 7, 8, 9, etc. In one aspect, the number may be 4, such that 5 emergency incident reports have been received. If the count is not greater than the threshold, then wait for another emergency incident report, block 960.

If the number of emergency incident reports that has been received is sufficient, then in block 970 determine if enough reports have been received within a determined period of time, for example 1 minute, or 2 minutes, or 3 minutes, or 4 minutes, or 5minutes, or 6 minutes, or 7 minutes, or 8 minutes, or 9 minutes, or 10 minutes, or 11minutes, or 12 minutes, or 13 minutes, or 14 minutes, or 15 minutes, or whatever time threshold is established. Although whole minutes are listed, one of skill in the art will recognize any partial minute as also sufficing, for example 47 seconds, or 6 minutes and 11 seconds, etc. If enough emergency incident reports are received within the threshold time, then begin the lockdown, block 930. If not, wait for another emergency report, block 960.

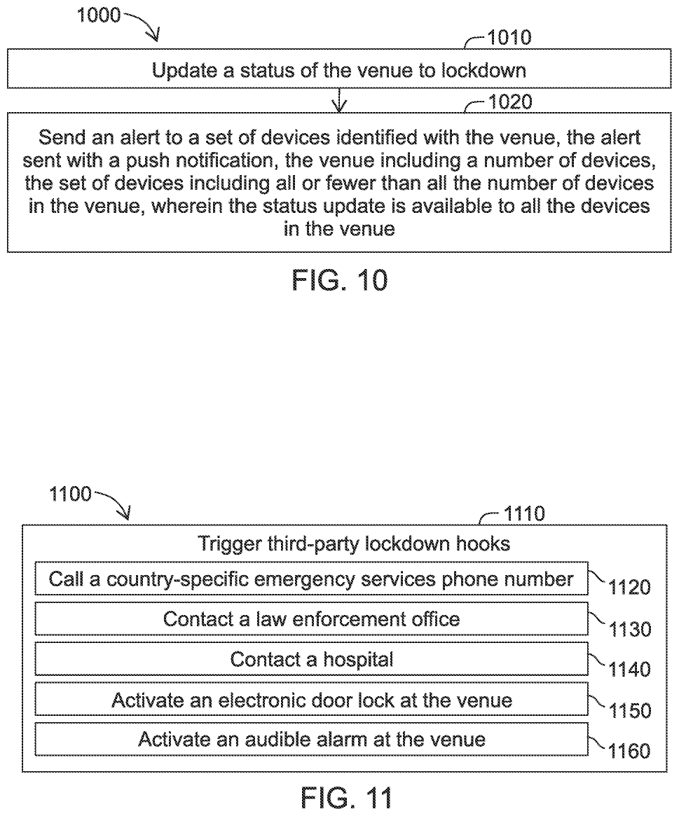

FIG. 10 is a block diagram illustrating process 1000 for beginning a lockdown for a venue. Once the criteria for a lockdown is met, reporting dashboard 730 may update a status of the venue to lockdown, block 1010. Once the venue status is updated, all users with App 127 open, or all users who open App 127, will have the updated status and may be aware of the lockdown. Some users 102 may have granted permission for push notification, so that regardless of whether App 127 is open, they will receive notification of the lockdown. Reporting dashboard 730 may send an alert to a set of mobile devices 104 identified with the venue. The alert may be sent with a push notification to mobile devices 104 for which user 102 has granted permission for push notifications, which may be all of fewer than all the devices (or people) associated with the venue. Users 102 who do not receive notification through the push (for example, if permission has not been granted) may still be notified of the lockdown if App 127 on their mobile device 104 is open or is opened, through the change in status for the venue.

FIG. 11 is a block diagram illustrating process 1100 for automatically engaging security protocols for a lockdown. In one aspect, security protocols that are included as third-party lockdown “hooks” may be universal, for example contacting emergency services. In one aspect, the security protocol may be tailored to a venue. A “hook” may be a piece of code, function, process, subroutine, etc. for performing a task relating to an entity not directly associated with the venue (for example, the lock manufacturer for the locks used in a workplace, or school, etc.). In one aspect, reporting dashboard 730 may trigger third-party lockdown hooks. These may be done sequentially, simultaneously, in groups, at a certain time or at certain times, or at a time that's beneficial for users 102, or partially (some lockdown hooks are engaged while others are not).

Examples of hooks may be an automated alert calling a country-specific emergency services phone number (placing a call, which when answered delivers a pre-recorded message requesting police assistance at the venue, for example), block 1120. Another example may include contacting a law enforcement office directly, for example using a phone line, a radio, or a message via the Internet, block 1130. In another example, reporting dashboard 730 may contact a hospital using a phone line, a radio, or a message via the Internet, block 1140. Another example may include activating an electronic door lock at the venue, block 1150. This may include all the locks at the venue, or only some of the locks at the venue, depending on security protocols. Another example may include activating an audible alarm at the venue, block 1160.

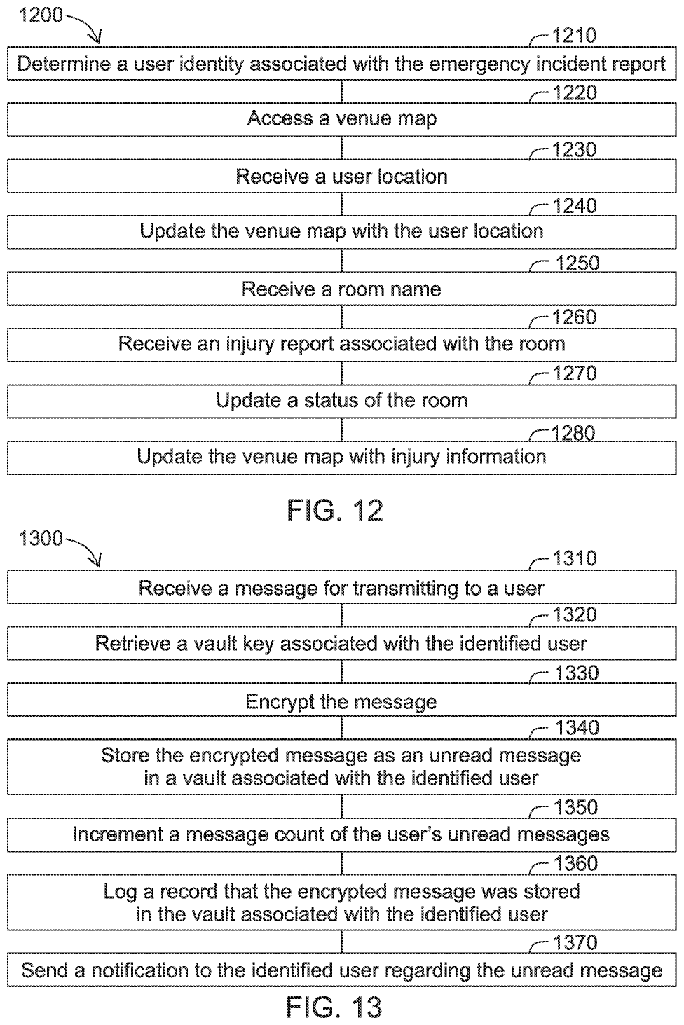

FIG. 12 is a block diagram illustrating process 1200 for tracking users 102 and injuries on a map. After receiving an emergency incident report from user 102, reporting dashboard 730 may determine a user identity associated with the emergency incident report, block 1210. As previously discussed, there may be different methods of determining user identity, for example the user identity may be contained in the emergency incident report, or there may be data in the emergency incident report that may be cross referenced to a database with the user's identity. In one aspect, block 1210 is optional and a user identity is not determined.

Reporting dashboard 730 may access a venue map or map information (for example an SVG file (scalable vector graphics) that is available and converted to GeoJSON layers), block 1220, and make the map available to responders, for example users 102 with a first tier privilege level. When user information is received, block 1230, reporting dashboard 730 may update the venue map with the user location, block 1240. In one aspect, over time as users 102 either submit emergency incident reports during an emergency, or grant permission to share their location, a map with information about how many users 102 are in each room, where users 102 are concentrated, what rooms may be unoccupied, and so on, is built.

Reporting dashboard 730 may receive a room name in block 1250 and an injury report associated with the room, block 1260. An injury report may come from user 102 and relate to themselves, relate to others around user 102, or both. In block 1270, a room status may be updated. Examples of room status include: Injured present, users reporting and no injuries, no reports, etc. In block 1280, the venue map may be updated with injury information. As previously described, the map may reflect room occupancy with icons, numbers, colors, and so on. Injury information may be binary, for example a room flagged as having injured occupants, or the map may reflect the number of injured in a room, or it may reflect the severity of the injury, or a combination. The venue map may be accessed by police with a first tier privilege level, be accessed from a smartphone or tablet and be used by an approach or entry team, for example a SWAT team responding to a shooting at a school or the appearance of a gun. In one aspect, the venue map may include an icon showing a user's present location on the map, so that navigation through the venue is possible.

FIG. 13 is a block diagram illustrating process 1300 for sending a message to user 102. In one aspect, a user 102 with first tier privilege level, who may be responding to the emergency at the venue, may send a message to user 102 at the venue, for example a student in a classroom. In one aspect, the situation is reversed and a user 102 at the venue may send a message to user 102, who may be a teacher, a principal, a SWAT officer, a counselor, and so on, who has access to reporting dashboard 730. Process 1300 may run entirely from reporting dashboard 730 or it may run partially from App 127 and partially from reporting dashboard 730. When a message is ready, the message is received for transmitting to user 102, block 1310. User 102 may be in the zone of the lockdown, a student for example, or user 102 may be a police captain, for example, and coordinating the response, or a principal, or a school resource office, for example.

Once the message is received, a vault key associated with user 102 is retrieved, block 1320 and the message is encrypted, block 1330. The unread message may be stored in a vault associated with user 102, block 1340 and a message counter incremented to track unread messages, block 1350. A record may be created with the information that the encrypted message was stored in a vault for user 102, block 1360. A notification may be sent of the unread message, block 1370.

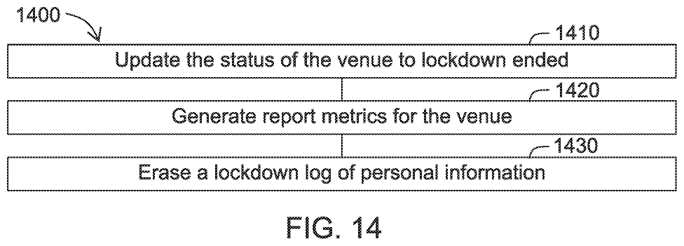

FIG. 14 is a block diagram illustrating process 1400 for ending the lockdown. At some point after a lockdown begins, authorities may determine that the situation, emergency, alarm, etc. that caused the lockdown to be triggered, will be resolved. Once over, the venue status may be updated from lockdown to “normal” in response dashboard 730, block 1410. All open Apps 127 will reflect that once they synchronize with response dashboard 730. Response dashboard 730 may generate a report metric for the venue, block 1420. The report may include some or all of the following: statistics around emergency incident reports; when users 102 responded; where users 102 were when they first responded; updated locations of users 102 throughout the event; user interactions with the app during the event; tracked locations of responders (if attending) throughout the event; messages sent and received during the event; interactions with the reporting dashboard during the event; notifications made during the event; any other aspects that contribute to reconstruction of the event for the purpose of after action review and investigation. In one aspect, a report metric (or report) may be generated for each privilege level. This may provide data on how quickly a venue reacted to the lockdown, and provide areas upon which to improve based on drills or practice lockdown scenarios. For example, for a school, each student may be evaluated on how quickly they respond, and each classroom may be evaluated on how quickly, as a whole, they respond, and each teacher on how quickly they respond (and how quickly doors are locked, lights go off and everyone goes silent). The report may help with after-action reviews of a real emergency, micro and macro performance evaluation (for all concerned and regardless of whether for a drill-simulated emergency-or an actual emergency), improvement, fine-tuning, benchmarking, etc. In one aspect, if a door was not locked for a particular classroom, an automated message may be sent to a school resource officer to ensure that the door can functionally lock (in the case that the lock is broken, as one example). Other types of messages may go out, for example informing users 102 of average response time, or average time to report a door locked/barricaded, or average time to report lights out or silent, and so on, as compared to each particular user 102 (meaning, each user 102 may see their performance compared to an average). Other information in the report may be data logging for event reconstruction. Once the report is generated, personal information may be erased and removed from the record, block 1430.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F) PLAs) or (field) programmable gate arrays ((F) PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for something” may be implemented as a “means configured to or suited for something”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps, or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts,-functions, -processes,-operations or-steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to also include features of a claim to any other independent claim even if this claim is not directly made dependent on the independent claim.

1. A mobile device, comprising:
a display;
one or more processors; and
a computer-readable medium storing instructions for execution by the one or more processors, the instructions when executed by the one or more processors causing the mobile device to:
check lockdown status;
present on the display an option for a user of the device to report an emergency;
receive a lockdown notification;
load a lockdown procedure;
update the display with a message regarding the lockdown notification;
generate a vault key;
transmit the vault key;
save the vault key;
generate an emergency script, the script relating to the lockdown; and
receive an end lockdown notification.

2. The device of claim 1, further comprising instructions to:
transmit an emergency incident report in response to the user having selected the option to report an emergency; and
transmit user information.

3. The device of claim 2, wherein the emergency incident report transmission further comprises emitting a signal from the mobile device using a wireless network to an emergency service provider.

4. The device of claim 2, wherein the user information includes at least one of a user identity, a venue, and a user privilege level.

5. The device of claim 4, wherein the user privilege level includes at least one of a student, a school official and a first responder.

6. The device of claim 4, where the venue includes a school identification.

7. The device of claim 1, further comprising instructions to:
transmit a location of the device.

8. The device of claim 1, further comprising instructions to:
request a room name; and
transmit the room name.

9. The device of claim 8, further comprising instructions to:
request an update on whether there is an urgent medical need from anyone in the room; and
transmit the urgent medical need update.

10. The device of claim 9, further comprising instructions to:
request an update on the number of people injured in the room; and
transmit the injured person update.

11. The device of claim 1, the emergency script further comprising directions to:
hide;
secure a door; and
turn off lights.

12. The device of claim 11, the direction to secure a door further comprising at least one of locking the door and creating a barrier.

13. The device of claim 11, the directions further comprising:
encouragement;
assurance that help is coming; and
a relaxation exercise.

14. A system comprising:
one or more computer processors; and
a non-transitory computer storage media storing instructions that when executed by the one or more computer processors cause the system to:
receive an emergency incident report;
determine a venue associated with the emergency incident report;
determine whether a lockdown for the venue should begin;
begin the lockdown for the venue; and
end the lockdown for the venue.

15. The system of claim 14, further comprising instructions to:
determine a user privilege level associated with the emergency incident report; and
begin the lockdown if the user privilege level is sufficient.

16. The system of claim 15, further comprising instructions to:
increment a counter if the user privilege level is insufficient; and
begin the lockdown when the counter is equal to a threshold.

17. The system of claim 15, further comprising instructions to:
begin a timer in response to receiving the emergency incident report, if the user privilege is insufficient;
receive an additional emergency incident report; and
begin the lockdown if the additional emergency incident report is received within a defined period of time.

18. The system of claim 16, further comprising instructions to:
begin a timer in response to receiving the emergency incident report;
receive an additional emergency incident report; and
begin the lockdown if the additional emergency incident report is received within a defined period of time and the counter is equal to the threshold.

19. The system of claim 14, further comprising instructions to:
update a status of the venue to lockdown.

20. The system of claim 19, further comprising instructions to:
send an alert to a set of devices identified with the venue, the alert sent with a push notification, the venue including a number of devices, the set of devices including all or fewer than all of the number of devices in the venue, wherein the status update is available to all the devices in the venue.

21. The system of claim 14, further comprising instructions to:
trigger third-party lockdown hooks.

22. The system of claim 21 wherein the third-party lockdown hooks further comprise at least one of: call a country-specific emergency services phone number, contact a law enforcement office, contact a hospital, activate an electronic door lock at the venue, or activate an audible alarm at the venue.

23. The system of claim 14, further comprising instructions to:
determine a user identity associated with the emergency incident report.

24. The system of claim 23, further comprising instructions to:
access a venue map;
receive a user location; and
update the venue map with the user location.

25. The system of claim 24, further comprising instructions to:
receive a room name; and
receive an injury report associated with the room name.

26. The system of claim 25, further comprising instructions to:
update a status of the room, the status relating to at least one of occupancy of the room and injury reports.

27. The system of claim 23, further comprising instructions to:
receive a message for transmitting to the identified user;
retrieve a vault key associated with the identified user;
encrypt the message; and
store the encrypted message as an unread message in a vault associated with the identified user.

28. The system of claim 27, further comprising instructions to:
increment a message count of the user's unread messages;
log a record that the encrypted message was stored in the vault associated with the identified user; and
send a notification to the identified user regarding the unread message.

29. The system of claim 19, further comprising instructions to: update the status of the venue to lockdown ended;
generate report metrics for the venue; and
erase a lockdown log of personal information.

30-35. (canceled)
